(19) United States
(12) Patent Application Publication
(10) Pub. No.: US 2026/0177367 A1
(43) Pub. Date: Jun. 25, 2026

(54) SHAPE MEASURING APPARATUS

(71) Applicant: MITUTOYO CORPORATION, Kawasaki-shi (JP)

(72) Inventors: Shota Sakakibara, Tochigi Prefecture (JP); Hiroshi Kamitani, Tochigi Prefecture (JP); Koichi Meguro, Tochigi Prefecture (JP)

(21) Appl. No.: 19/371,392

(22) Filed: Oct. 28, 2025

(30) Foreign Application Priority Data
Oct. 29, 2024 (JP) 2024-190187

(51) Int. Cl. G01B 5/00; G01B 5/012; G01B 5/28

(52) U.S. Cl. CPC G01B 5/0002; G01B 5/012; G01B 5/28

(57) ABSTRACT

There is provided a shape measuring apparatus capable of automatically measuring a shape of a complex-shaped object to be measured quickly and accurately. A translation movement mechanism and a rotary drive mechanism relatively move a probe and a workpiece in such a manner that the probe performs a scanning measurement on the workpiece along a preset scanning path. At this time, the rotary drive mechanism is driven and controlled in such a manner that an angle formed between the probe and a surface of the workpiece is a desired angle in synchronization with the translation movement mechanism relatively moving the probe and the workpiece.

### INCORPORATION BY REFERENCE

This application is based upon and claims the benefit of priority from JP patent application No. JP 2024-190187, filed on Oct. 29, 2024 (DAS code C502), the disclosure of which is incorporated herein in its entirety by reference.

### BACKGROUND OF THE INVENTION

### 1. Field of the Invention

The present invention relates to a shape measuring apparatus.

### 2. Description of Related Art

There is a known shape measuring apparatus that measures the shape of an object to be measured by causing a contact point to perform a scanning movement along a surface of the object to be measured (see, for example, see JP 5274782 B, JP 6030339 B, JP 6063161 B, JP 7402653 B, and JP 7344626 B).
[Patent Literature 1] JP 5274782 B
[Patent Literature 2] JP 6030339 B
[Patent Literature 3] JP 6063161 B
[Patent Literature 4] JP 7402653 B
[Patent Literature 5] JP 7344626 B

### SUMMARY OF THE INVENTION

Recently, shapes of objects to be measured have been rather complicated. Furthermore, it has been also required to measure (inspect) points that have not been measured (inspected) before. Moreover, there is a growing need to perform scanning measurements on complex-shaped workpieces quickly and accurately. However, due to labor shortages, it is not practical to perform these complex and difficult measurements (inspections) one by one while making fine adjustments by hand and taking time. Therefore, it is required to perform measurement operations efficiently and automatically.

For example, it is now required to accurately measure (inspect) the surface contour of a curved surface, such as a tooth surface of a gear, and to accurately evaluate detailed surface texture, such as surface roughness. However, in order to accurately measure a surface contour or surface roughness, it is essential to perform a scanning measurement while maintaining a state of a stylus (probe) being in contact with at a predetermined angle with respect to the surface of a workpiece (specifically, the stylus displacement direction and the surface of the workpiece need to be perpendicular). For this reason, in the past, the roughness of such curved surfaces was either not evaluated or manually measured by selecting a few samples.

There is a demand for a shape measuring apparatus capable of automatically measuring a shape of a complex-shaped object to be measured quickly and accurately.

A purpose of the present invention is to provide a shape measuring apparatus capable of automatically measuring a shape of a complex-shaped object to be measured quickly and accurately.

A shape measuring apparatus according to an exemplary embodiment of the present invention includes:
a translation movement mechanism; and
a rotary drive mechanism, in which
the translation movement mechanism and the rotary drive mechanism relatively move a probe and a workpiece to cause the probe to perform a scanning measurement on the workpiece along a preset scanning path, and
the rotary drive mechanism is driven and controlled in such a manner that an angle formed between the probe and a surface of the workpiece is a desired angle in synchronization with the translation movement mechanism relatively moving the probe and the workpiece.

### BRIEF DESCRIPTION OF THE DRAWINGS

FIG. 1 is a diagram showing an overall configuration of a shape measuring system;

FIG. 2 is a side view of a surface roughness measuring unit;

FIG. 3 is a diagram for explaining an internal mechanism of a stylus unit;

FIG. 4 is a diagram showing an example of a rotary drive mechanism;

FIG. 5 is a functional block diagram of a host computer and a motion controller;

FIG. 6 is a diagram schematically showing the relationship between design data and a PCC curve;

FIG. 7 is a diagram showing an example of a PCC curve;

FIG. 8 is a functional block diagram of the motion controller;

FIG. 9 is a diagram showing examples of PCC curve data about a scanning path, a Translation velocity pattern, and a rotation command;

FIG. 10 is a diagram schematically showing that a tooth surface of a gear is measured;

FIG. 11 is a diagram schematically showing that a tooth surface of a gear is measured;

FIG. 12 is a diagram showing a configuration of a motion controller in a second exemplary embodiment;

FIG. 13 is a diagram showing an example of changes in a normal line direction on a surface of a workpiece;

FIG. 14 is a diagram showing an example of a probe; and

FIG. 15 is a diagram showing that a probe measures a blade.

### DETAILED DESCRIPTION

Embodiments of the present invention will be illustrated and described with reference to reference signs assigned to elements in the drawings.

Note that, each embodiment may be implemented independently, or two or more embodiments may be implemented in combination, and modifications added in each embodiment are applicable to other embodiments.

### First Exemplary Embodiment

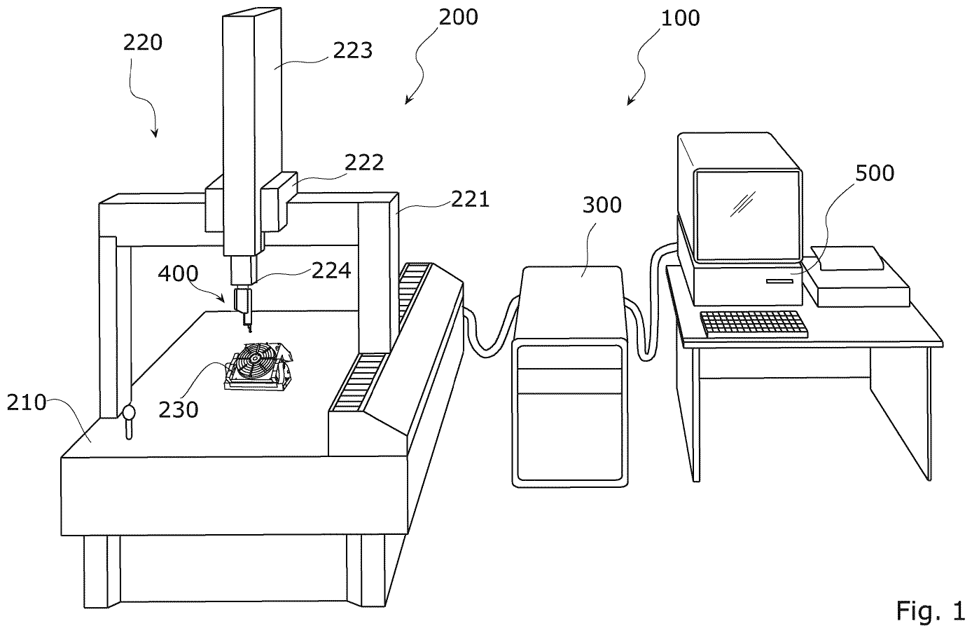

FIG. 1 is a diagram showing an overall configuration of a shape measuring system (shape measuring apparatus) 100.

The structural hardware part of the shape measuring system 100 is basically known and will be described briefly.

The shape measuring system 100 includes a Coordinate Measuring Machine 200, a motion controller 300 that controls the drive of the Coordinate Measuring Machine 200, and a host computer 500 that controls the motion controller 300 and performs necessary data processing.

In this specification, a shape measurement is not limited to acquiring measurement values related to a shape itself, such as contours and dimensions, but also includes acquiring parameters representing the properties (features) of a shape, such as surface textures (roughness and undulation), and broadly includes acquiring measurement values obtained by detecting a surface of a workpiece.

The Coordinate Measuring Machine 200 includes a measuring table 210, a translation movement mechanism 220, a probe 400, and a rotary drive mechanism 230.

The translation movement mechanism 220 and the rotary drive mechanism 230 constitute a movement mechanism.

The translation movement mechanism 220 includes a gate-shaped Y slider 221, an X slider 222, a Z axis column 223, and a Z spindle 224. The Y slider 221 is provided so as to be slidable on the measuring table 210 in a Y direction. The X slider 222 slides along a beam of the Y slider 221 in an X direction. The Z axis column 223 is fixed to the X slider 222. The Z spindle 224 moves up and down inside the Z axis column 223 in a Z direction.

In other words, in the present exemplary embodiment, the translation movement mechanism 220 has three translation drive axes (an X-direction translation drive axis, a Y-direction translation drive axis, and a Z-direction translation drive axis).

With each of the Y slider 221, the X slider 222, and the Z spindle 224, a driving motor (not shown) and an encoder (not shown) are attached. The driving motors are driven and controlled by a drive control signal from the motion controller 300. The encoders detect the respective movement amounts of the Y slider 221, the X slider 222, and the Z spindle 224 and output the detection values to the motion controller 300. The probe 400 is attached to the lower end of the Z spindle 224.

As the probe 400, a surface roughness measuring unit 400 is employed as an example in the present exemplary embodiment.

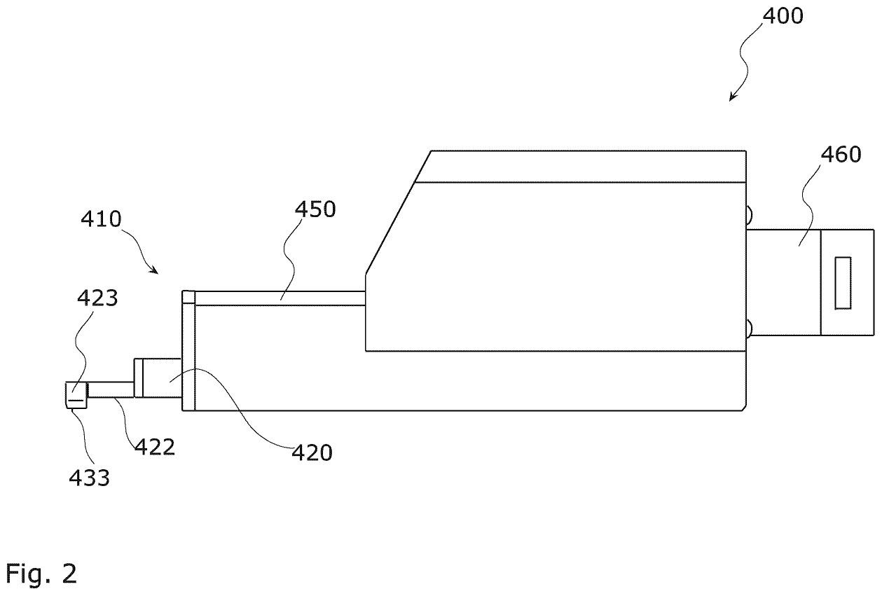

FIG. 2 is a side view of the surface roughness measuring unit 400.

The surface roughness measuring unit 400 includes a stylus unit 410, an outer housing 450, and a joint 460.

The surface roughness measuring unit 400 is connected to the movement mechanism (specifically, the lower end of the Z spindle 224) by the joint 460.

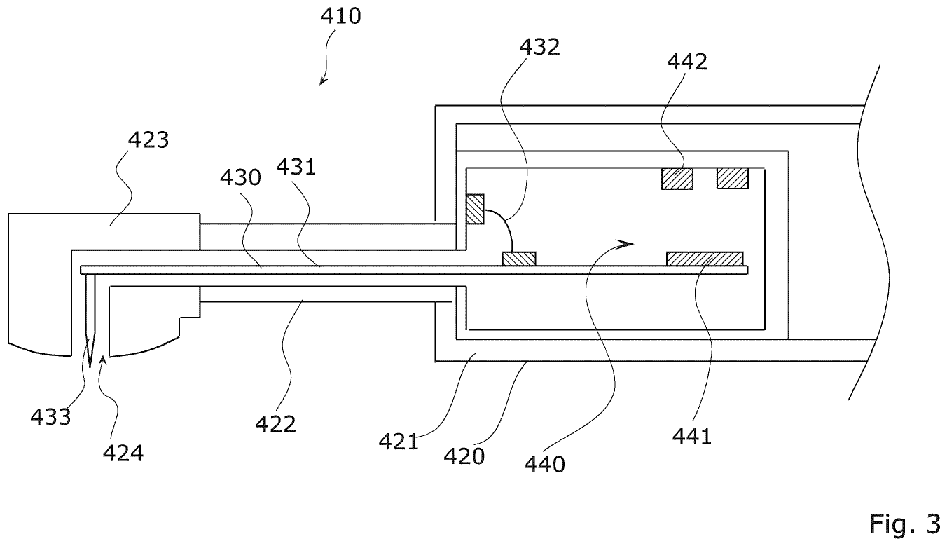

FIG. 3 is a diagram for explaining the internal mechanism of the stylus unit 410.

The stylus unit 410 includes a case body 420 having an internal space, a stylus lever 430 provided so as to rock (seesaw) within the case body 420, and a displacement detection part 440.

The case body 420 includes a substantially rectangular trunk part 421 and a nose part 422 protruding from the tip of the trunk part 421. A skid 423 is provided at the tip of the nose part 422.

The skid 423 includes a through hole 424 bent in an L-shape thereinside, and the through hole 424 is continuous with a hollow inside the nose part 422.

The stylus lever 430 is a stylus having a L shape as a whole.

The stylus lever 430 includes a straight rod-shaped rocking lever 431 and a stylus 433 disposed at the tip of the rocking lever 431 in a direction perpendicular to the rocking lever 431.

(In FIGS. 2 and 3, the stylus 433 is provided facing downward.)

(For convenience of explanation, the vertical direction of the surface roughness measuring unit 400 is expressed by defining the upper and lower sides shown in FIGS. 2 and 3. In addition, the left side of the drawings is expressed as the front side of the surface roughness measuring unit 400, and the right side of the drawings is expressed as the rear side of the surface roughness measuring unit 400.)

(please do not be too particular (hung up) about just “naming” of components (parts, elements). A rocking lever can be referred to as seesaw lever or seesaw-type lever. Please do not be too particular (hung up) about the naming of components (parts, elements), and please do not intentionally interpret the examples in an unfavorable way.)

Here, it can be said that the direction of the stylus 433 or the vertical displacement direction of the stylus 433 is the direction of the measurement axis of the surface roughness measuring unit 400, which is a probe.

The stylus lever 430 is inserted from the trunk part 421 to the nose part 422, and the stylus 433 at the tip is disposed so as to face outward through the lower end opening of the skid 423. The stylus lever 430 is attached to the internal space of the trunk part 421 at its intermediate portion by a plate spring 432. The plate spring 432 serves as the rocking fulcrum for the stylus lever 430, and elastically supports the stylus lever 430 in such a manner that the stylus 433 is balanced with the stylus 433 protruding slightly from the lower surface of the skid 423.

The displacement detection part 440 is disposed inside the trunk part 421. The displacement detection part 440 includes a ferrite plate 441 and an inductance detector 442.

The ferrite plate 441 is attached to the rear upper surface of the stylus lever 430. The inductance detector 442 is attached at a position facing the ferrite plate 441 in the internal space of the trunk part 421.

The lower surface of the skid 423 is a workpiece contact surface that is brought into contact with a workpiece W during measurement. When the lower surface of the skid 423 moves along a measurement surface of the workpiece W, the stylus 433 moves up and down due to the surface roughness of the measurement surface. When the stylus 433 moves up and down, this up/down movement is detected by the inductance detector 442. The surface roughness (surface irregularities) of the measurement surface of the workpiece W is measured based on a detection signal output from the inductance detector 442. The stylus unit 410 outputs a measurement result of the surface roughness of the measurement surface of the workpiece W to an external device. (The measurement result may be output to the motion controller 300 or directly to the host computer 500.)

The outer housing 450 accommodates the stylus unit 410, and is provided with the joint 460 at its rear end. The outer housing 450 accommodates the stylus unit 410 in such a manner that the front end of the stylus unit 410 is exposed from the front end of the outer housing 450.

In general, in a case of the surface roughness measuring unit 400 used alone, a power mechanism that slides the stylus unit 410 in the front-rear direction, and an encoder that detects the displacement thereof are provided inside the outer housing 450. The surface roughness measuring unit 400 employed in the present exemplary embodiment may also include such a power mechanism and an encoder. In this case, the power mechanism that slide the stylus unit 410 in the front-rear direction can be interpreted as being included in a “movement mechanism (translation movement mechanism 220).” However, the present exemplary embodiment assumes that the stylus unit 410 is moved mainly by the translation movement mechanism 220, and therefore, the relative movement between the stylus unit 410 and a workpiece is achieved by the movement mechanism (the translation movement mechanism 220 and the rotary drive mechanism 230). The description of the power mechanism and encoder in the outer housing 450 of the surface roughness measuring unit 400 is omitted.

Here, a roughness measuring device with a skid is described as an example, but a skidless roughness measuring device without a skid may also be used. The name “roughness measuring device” is not important, and may be referred to as a scanning probe or a contour measuring device.

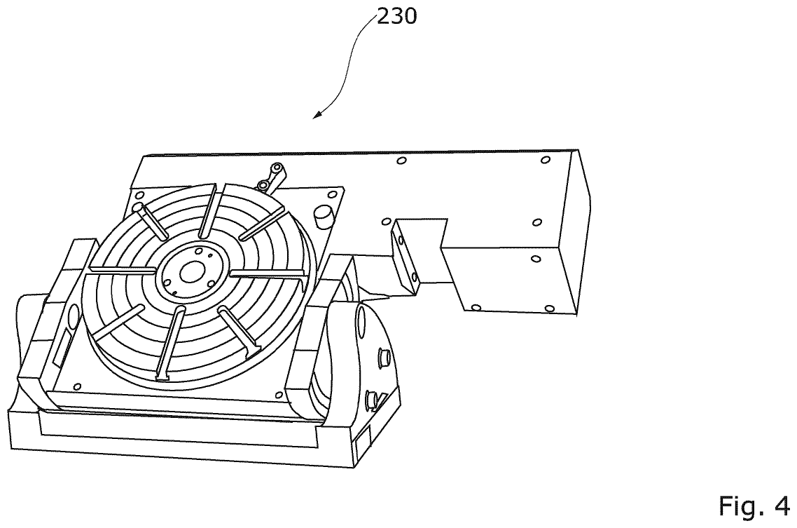

FIG. 4 is a diagram showing an example of the rotary drive mechanism 230.

The rotary drive mechanism 230 is a rotary table mechanism mounted on the measuring table 210. The rotary drive mechanism 230 rotates a rotary table using an internal motor (not shown). The rotary drive mechanism 230 has two rotation axes (rotation drive axes) and is a tilting rotary table mechanism that can further tilt the rotary table.

In order to handle complex-shaped workpieces, it is desirable to configure the rotary drive mechanism 230 with multiple axes (two axes in this case), but a single rotary axis is also acceptable.

(For example, if a surface to be measured, which is a curved surface, is parallel to a specific single axis, a single rotation axis may is sufficient.)

In the present exemplary embodiment, since it is sufficient to rotate a gear around a single axis (for example, the Y-axis) to measure the tooth surface of the gear, the rotary drive mechanism 230 with a single axis is sufficient to have a rotary axis parallel to the Y-axis. The rotary drive mechanism 230 does not need to be a rotary table and may rotate a workpiece (gear) by chucking the axis of the workpiece (the shaft of the gear or shaft hole).

### (Configuration of Host Computer 500)

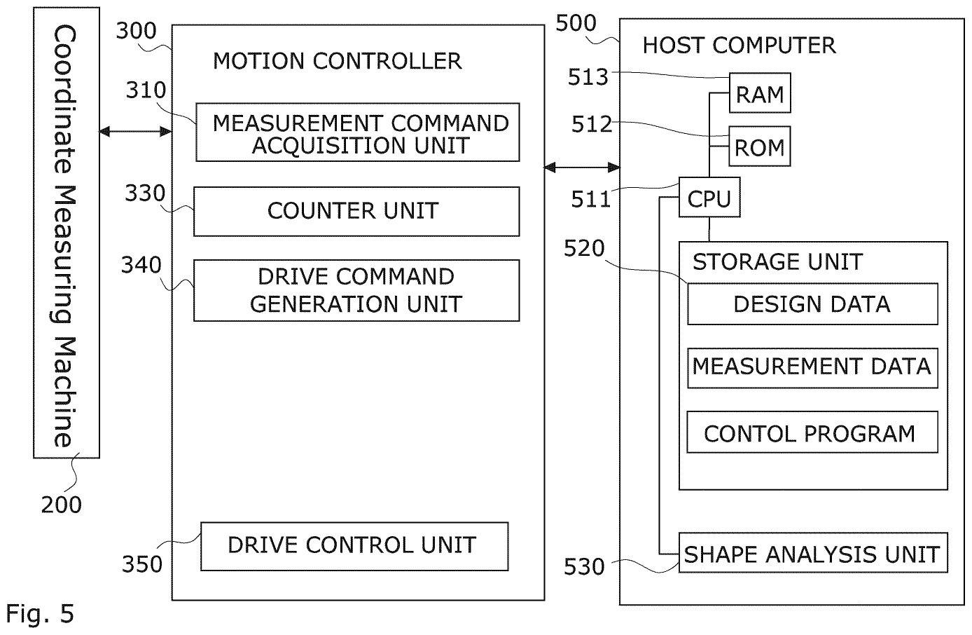

Next, the host computer 500 is described. FIG. 5 is a functional block diagram of the host computer 500 and the motion controller 300. The host computer 500 includes a central processing unit (CPU) 511, and a memory, and controls the Coordinate Measuring Machine 200 via the motion controller 300. The CPU 511 executes a measurement control program, and thus the measurement operation of the present exemplary embodiment is implemented. In other words, the measurement control program may be executed to implement each functional unit of the host computer 500 and the motion controller 300. The measurement control program may be recorded on a non-volatile recording medium (a CD-ROM, a memory card, or the like) and distributed, or may be downloaded via an Internet connection or the like. The host computer 500 is connected to output devices (such as a display and a printer) and input devices (such as a keyboard and a mouse) as needed.

The host computer 500 includes a storage unit 520 and a shape analysis unit 530.

The storage unit 520 stores design data related to a shape of an object to be measured (workpiece) W, such as CAD data or NURBS data, measurement data obtained in measurement, and the measurement control program that controls a whole measurement operation.

The shape analysis unit 530 calculates surface shape data about the object to be measured based on the measurement data output from the motion controller 300, and performs shape analysis to obtain errors, distortions, roughness (surface texture), and the like of the calculated surface shape data about the object to be measured.

In addition, the shape analysis unit 530 generates measurement command data by, for example, converting design data (such as CAD data or NURBS data) containing scanning path information into a PCC curve.

Here, the generation of measurement command data is explained.

In the present exemplary embodiment, the Coordinate Measuring Machine 200 rotates the rotary drive mechanism 230 according to the shape of a workpiece, but it is assumed that, instead of an operator setting a rotation command, the motion controller 300 (or the host computer 500) automatically generates a rotation command from the PCC curve of a scanning path. Therefore, in the present exemplary embodiment, the operator sets a scanning path as in a conventional manner, and the shape analysis unit 530 of the host computer 500 converts the scanning path into a PCC curve, generates measurement command data, and provides it to the motion controller 300.

An example of a procedure for converting design values (for example, non-uniform rational B-spline (NURBS) data) of a scanning path based on CAD data or the like into polynomial curves with a predetermined degree is briefly explained below.

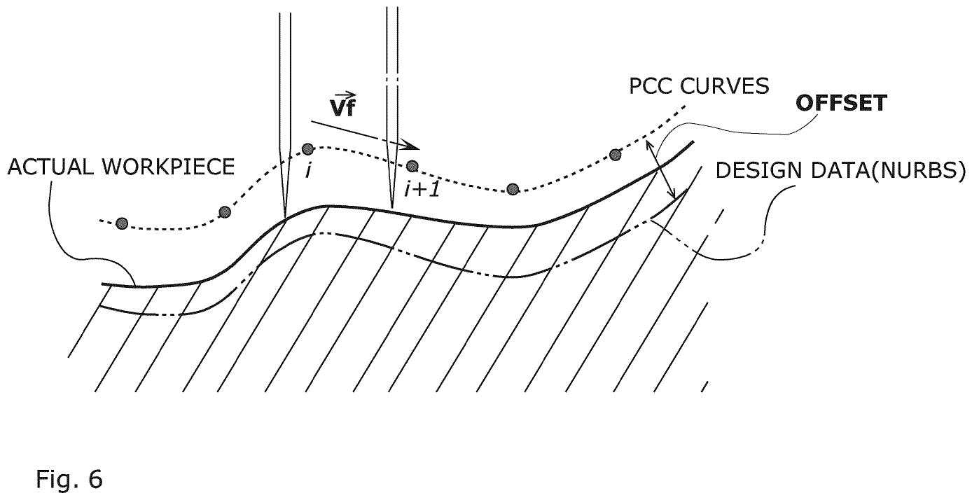

FIG. 6 is a diagram schematically showing the relationship between design data and a PCC curve.

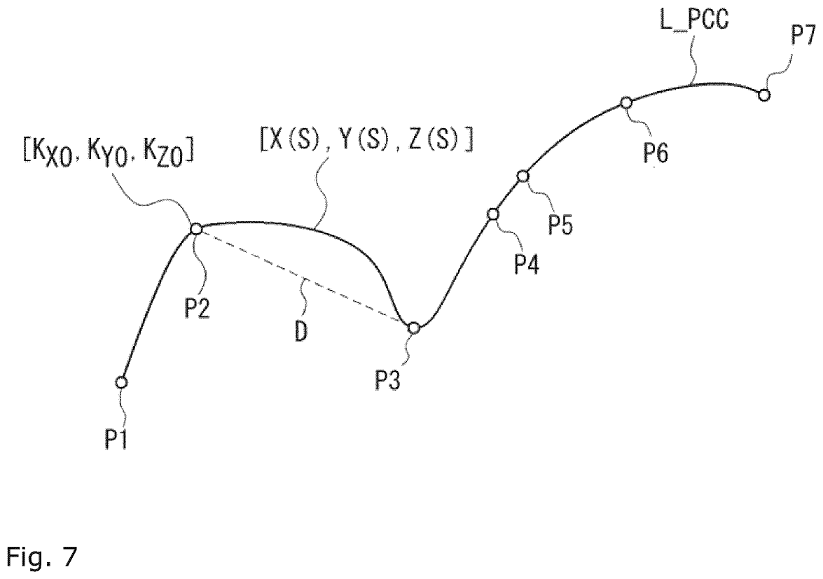

FIG. 7 is an example of a PCC curve.

The host computer 500 receives CAD data (for example, NURBS data) containing path information from an external CAD system or the like, and converts the CAD data into point group data.

The data about each point is a combination of coordinates (x, y, z) and normal line directions (P, Q, R), that is, (x, y, z, P, Q, R). In this specification, the point group data containing the information (x, y, z, P, Q, R) is referred to as contour point data.

Next, as necessary, the coordinates of each point are offset in the normal line direction by a predetermined amount. The predetermined offset amount is set by considering, for example, a reference point of the position (coordinates) of the probe 400 (stylus lever 430), a distance from the reference point to the tip of the probe 400 (stylus 433), and an estimated deflection amount based on a predetermined measurement pressure. The point group data obtained in this manner is referred to as offset contour point data.

The offset contour point data is converted into polynomial curves with a predetermined degree. Here, it is assumed that the polynomial is a cubic function, and the curves are parametric cubic curves (PCC curves). A path for measuring a workpiece is generated based on the PCC curves. Furthermore, the PCC curves are divided into divided PCC curves.

An example of a PCC curve is shown in FIG. 7.

There is a continuous PCC curve L_PCC from a point P1 to a point P7, and the PCC curve L_PCC is divided into multiple segments by points P. (Each segment is also a PCC curve.) The end point of each segment is the start point of the next segment (PCC curve). The coordinates of the start point of a segment are expressed as (K_{X0}, K_{Y0}, K_{Z0}), and the length of the straight line between the start point and the end point of the PCC curve is expressed as D. With this definition, the coordinates {X(S), Y(S), Z(S)} at any position on the PCC curve can be expressed using the coefficients (K_{X3}, K_{X2}, . . . , K_{Z1}, K_{Z0}) for expressing a cubic curve, as follows:

X(S)=K_{X3}S³+K_{X2}S²+K_{X1}S+K_{X0}

Y(S)=K_{Y3}S³+K_{Y2}S²+K_{Y1}S+K_{Y0}

Z(S)=K_{Z3}S³+K_{Z2}S²+K_{Z1}S+K_{Z0}

### (Configuration of Motion Controller 300)

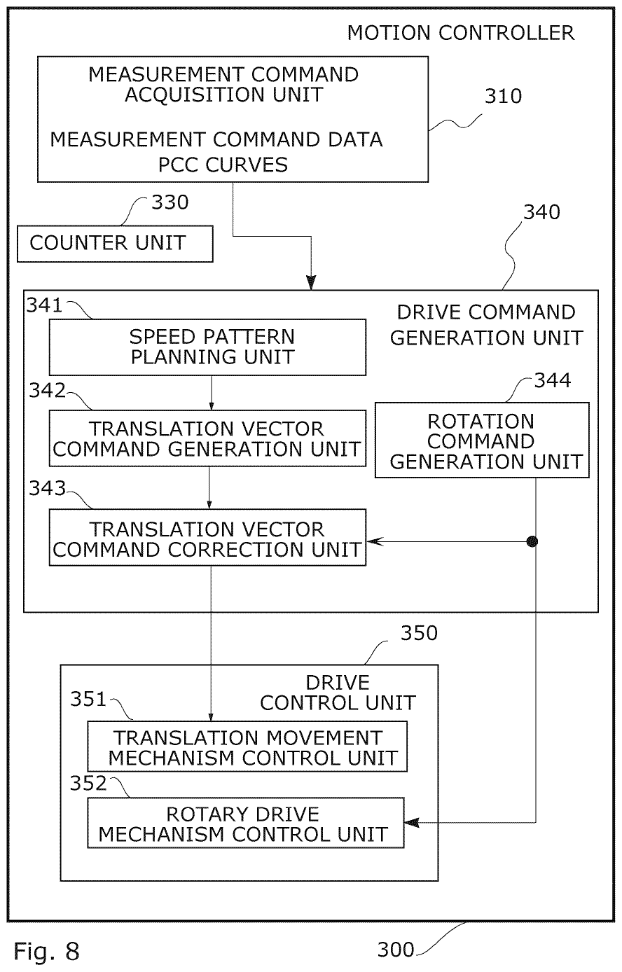

FIG. 8 is a functional block diagram of the motion controller 300.

The motion controller 300 is described below.

The motion controller 300 includes a measurement command acquisition unit 310, a counter unit 330, a drive command generation unit 340, and a drive control unit 350.

The measurement command acquisition unit 310 acquires measurement command data from the host computer 500. Here, the measurement command data is the PCC curve of the scanning path described above.

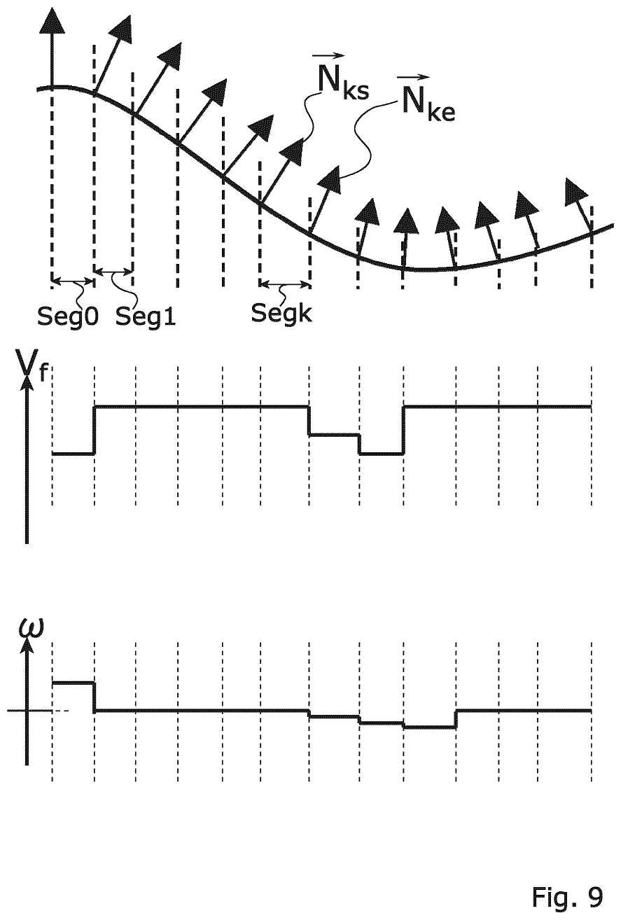

Now, it is assumed that PCC curve data about the scanning path, as shown in the upper part of FIG. 9, is provided as the measurement command data. In the upper part of FIG. 9, it is assumed that the PCC curve is divided based on a curvature change, that is, the PCC curve is divided into segments (Seg). In the upper part of FIG. 9, for the sake of explanation, the normal line directions of the surface of the workpiece at the start and end points of each segment are shown.

The counter unit 330 counts detection signals output from the encoders of the translation movement mechanism 220 to measure the displacement of each slider. Similarly, the counter unit 330 counts detection signals detected from a rotary encoder of the rotary drive mechanism 230 to obtain the rotation angle of the rotary drive mechanism 230. As a result, the coordinate values of the surface of the workpiece currently being measured by the stylus 433 of the probe 400 (surface roughness measuring unit 400) are obtained.

The drive command generation unit 340 includes a speed pattern planning unit 341, a translation vector command generation unit 342, a rotation command generation unit 344, and a translation vector command correction unit 343.

The speed pattern planning unit 341 divides a PCC curve into divided PCC curves, and further calculates speed curves from the divided PCC curves. In other words, the movement speed (movement vector) of the probe 400 (surface roughness measuring unit 400) by the translation movement mechanism 220 is calculated. Based on the curvature of each segment of the divided PCC curves or the like, the movement speed (movement vector) of the probe 400 (surface roughness measuring unit 400) by the translation movement mechanism 220 is set, thereby generating a speed pattern plan shown in the middle part of FIG. 9. Note that the present applicant detailedly discloses in, for example, JP 6063161 B how to apply a speed pattern to each segment of PCC curves obtained by dividing a PCC curve to generate a series of speed pattern plans as shown in the middle part of FIG. 9.

The translation vector command generation unit 342 generates a translation vector command Vf as a drive command for the translation movement mechanism 220 in accordance with the speed pattern plan. Note that, in the present exemplary embodiment, the translation vector command Vf does not directly serve as a command to drive the translation movement mechanism 220, as described later. Instead, a corrected translation vector command Vf_{AMD}, which has been corrected by the translation vector command correction unit 343, serves as a command to drive the translation movement mechanism 220. This point will be explained later.

The rotation command generation unit 344 generates a rotation command as a drive command for the rotary drive mechanism 230.

In the present exemplary embodiment, instead of an operator setting a rotation command, the rotation command generation unit 344 automatically generates a rotation command. Here, it is assumed that a rotation command for the rotary drive mechanism 230 is not provided as coordinate values (angle value) but as a real-time “angular velocity”.

Referring to the upper and middle parts of FIG. 9, when a scanning measurement (surface roughness measurement) is performed on, for example, a k-th segment, the required rotation command (angular velocity command) is generated based on the difference in the normal line directions of the workpiece at the start point and the end point of the k-th segment.

Now, the normal line direction at the start point of the k-th segment is denoted as a normal line vector Nks.

The normal line direction at the end point of the k-th segment is denoted as a normal line vector Nke.

Then, the change in the normal line direction of the workpiece while the probe 400 (surface roughness measuring unit 400) performs the scanning measurement on the k-th segment is given by the angle formed between the normal line vector Nks and the normal line vector Nke.

The change in the normal line direction of the workpiece during the scanning measurement on the k-th segment is expressed as Δθk(Nke;Nks).

Now, a time tk required for measuring the k-th segment can be obtained from a translation movement speed Vfk set by the speed pattern planning unit 341 for performing the scanning measurement on the k-th segment and the length (distance) of the k-th segment. The rotary drive mechanism 230 is rotated so as to cancel out (compensate for) the change in the normal line direction of the workpiece during the scanning measurement on the k-th segment.

At this time, a rotation command (angular velocity command) ωok is set as follows.

ωk=Δθk(Nke;Nks)/tk

The translation vector command correction unit 343 performs correction processing on the translation vector command Vf generated by the translation vector command generation unit 342 so as to compensate for the rotation of the rotary drive mechanism 230, thereby generating the corrected translation vector command Vf_{AMD}.

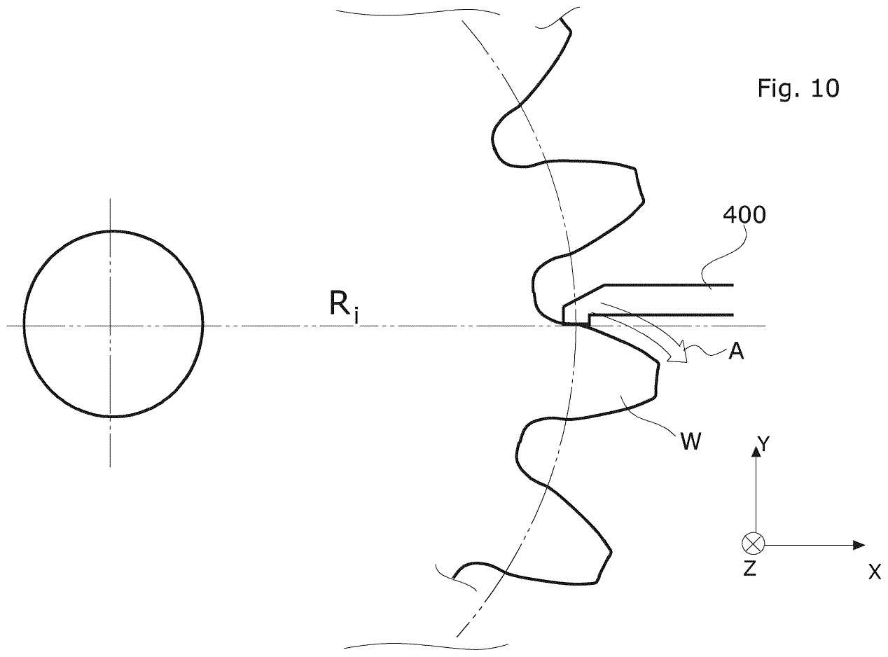

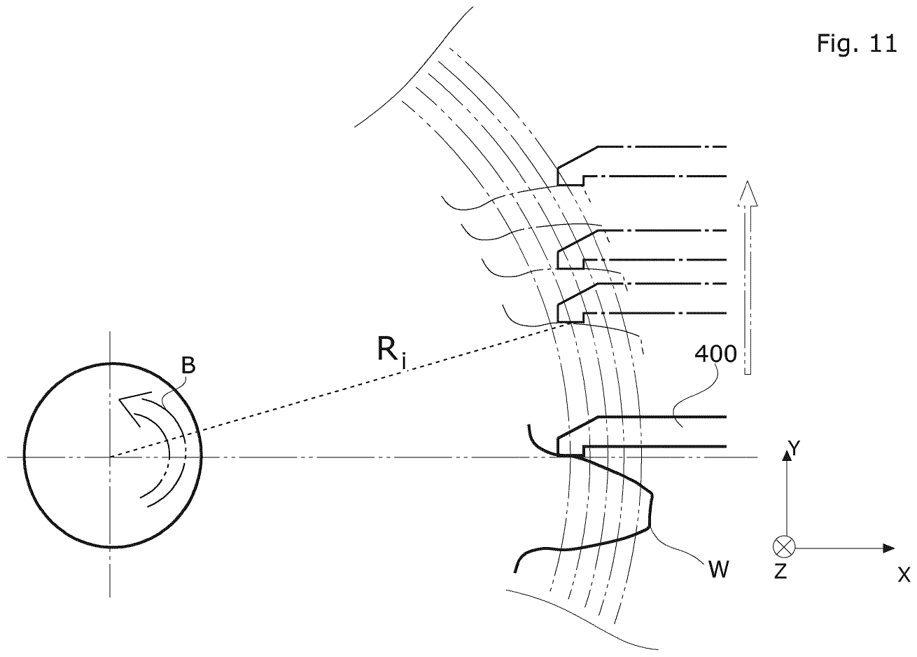

Now, it is assumed that, instead of the probe 400 (surface roughness measuring unit 400) moving along the tooth surface of the gear by the translation movement mechanism 220 toward the lower right in FIG. 10 (the arrow A in FIG. 10), the rotary table 251 rotates to the right (the arrow B in FIG. 11).

In this case, the translation vector command Vf is corrected so as to compensate for the rotation of the rotary drive mechanism 230.

The vector from the rotation axis of the rotary drive mechanism 230 to the probe 400 (surface roughness measuring unit 400; specifically, the contact point between the tip of the stylus 433 and the surface of the workpiece) is denoted as a radius vector Ri.

In addition, the angular velocity vector of the rotary drive mechanism 230 is denoted as ok.

The velocity (vector) of the rotary drive mechanism 230 at the position of the probe 400 (surface roughness measuring unit 400) (specifically, the contact point between the tip of the stylus 433 and the surface of the workpiece) is expressed as Vθk=ωk×Ri.

By adding the component of Vθk to the translation vector command Vfk, the corrected translation vector command Vf_{AMD} is obtained. (Gf and Gθ are appropriate gains.)

Corrected translation vector command Vfk_{AMD}=Gf×Vfk+Gθ×Vθk

The drive control unit 350 includes a translation movement mechanism control unit 351 that drives and controls the translation movement mechanism 220, and a rotary drive mechanism control unit 352 that drives and controls the rotary drive mechanism 230.

The translation movement mechanism control unit 351 is provided with the corrected translation vector command Vfk_{AMD} from the translation vector command correction unit 343.

The rotary drive mechanism control unit 352 is provided with the rotation command ok as a rotation drive command from the rotation command generation unit 344.

The corrected translation vector command Vfk_{AMD} and the rotation command ok are synchronized and provided to the translation movement mechanism control unit 351 and the rotary drive mechanism control unit 352, respectively.

The translation movement mechanism control unit 351 provides the translation movement mechanism 220 with a translation drive signal based on the corrected translation vector command Vfk_{AMD}.

The rotary drive mechanism control unit 352 provides the rotary drive mechanism 230 with a rotation drive signal based on the rotation command wk.

At this time, the translation movement mechanism 220 and the rotary drive mechanism 230 are driven in synchronization.

As a result of the translation movement mechanism 220 and the rotary drive mechanism 230 being driven in synchronization, a scanning measurement operation as shown in FIG. 11 is achieved, for example. That is, as an example, the probe 400 (surface roughness measuring unit 400) is moved only almost straight in the Y-axis direction by the translation movement mechanism 220.

In synchronization with this, the rotary drive mechanism 230 rotates left and right.

At this time, regarding the normal line direction of the workpiece, during the probe 400 (surface roughness measuring unit 400) performing the scanning measurement on the surface of the workpiece, the normal line direction of the surface of the workpiece at the contact point between the tip of the stylus 433 and the surface of the workpiece (that is, the measurement point) should not be changed. Therefore, if the stylus 433 approaches the surface of the workpiece so as to be perpendicular to the surface of the workpiece at the initial start point, the stylus 433 will remain perpendicular to the surface of the workpiece throughout subsequent scanning measurements. In other words, the surface roughness measuring unit 400 can properly perform a surface roughness measurement on a curved surface, such as a tooth surface of a gear.

As measurement data, the three-dimensional coordinates of the probe 400 (surface roughness measuring unit 400) are acquired by the encoders of the translation movement mechanism 220, and the rotation amount of the rotary drive mechanism 230 is acquired by the rotary encoder. (If the probe 400 (surface roughness measuring unit 400) itself includes a power mechanism and an encoder, the displacement of the probe 400 itself can also be obtained.) In order to analyze the shape of the workpiece (object to be measured), the displacement amount and rotation amount from these drive mechanisms are taken into account to convert the measurement point coordinates.

According to the present exemplary embodiment with such a configuration, it is possible to perform a scanning measurement utilizing the rotation of the rotary drive mechanism 230. Furthermore, during the probe 400 (surface roughness measuring unit 400) performing the scanning measurement on the surface of a workpiece, it is possible for the relative posture between the measurement axis of the probe and the workpiece at the contact point (that is, the measurement point) between the probe 400 (surface roughness measuring unit 400) and the surface of the workpiece to be maintained or to be controlled (adjusted) to a desired value. By utilizing the rotation of the rotary drive mechanism 230, the drive amount of the translation movement mechanism 220 is reduced, thereby improving the measurement speed (measurement efficiency).

In the present exemplary embodiment, the posture of the probe 400 (surface roughness measuring unit 400) does not change, and the probe 400 (surface roughness measuring unit 400) is only moved in parallel (translation) by the translation movement mechanism 220. In a surface roughness measurement, the angle between the stylus 433 and the surface of a workpiece is important, and this is achieved by rotating the workpiece using the rotary drive mechanism 230 to adjust the posture of the workpiece. In this manner, the fact that the posture of the probe 400 (surface roughness measuring unit 400) does not change (in other words, the probe does not rotate) during a scanning measurement on a workpiece is a significant advantage, especially when using a probe whose posture change easily lead to variations in measurement conditions, such as measurement pressure.

In the present exemplary embodiment, one Translation axis and one rotation axis can be driven during a measurement operation. By simplifying the movement during the measurement operation as much as possible in this manner, it is possible to minimize measurement error factors, such as drive errors (trajectory errors) and speed variations, in the movement mechanism (the translation movement mechanism 220, the rotary drive mechanism 230). This means that it is possible to achieve dramatically higher measurement accuracy for a complex-shaped workpiece that has been previously difficult to measure, for example.

In the present exemplary embodiment, in order to perform a scanning measurement (surface roughness measurement) on a tooth surface of a gear, the tooth surface is measured using synchronized control combining one translation drive axis (Y-direction translation drive axis) and one rotation drive axis. However, in order to continuously measure another tooth surface, another surface, or an end face, it is also possible to measure the surface to be measured using synchronized control combining another translation drive axis (for example, the X-direction translation drive axis) and another rotation drive axis. The number of drive axes that are driven simultaneously is limited to one translation drive axis of the translation movement mechanism 220 and one rotation drive axis of the rotary drive mechanism 230. In this manner, by reducing the number of drive axes moving simultaneously, it is possible to improve the measurement accuracy and measurement efficiency.

### Second Exemplary Embodiment

Next, a second exemplary embodiment of the present invention will be described.

The second embodiment is characterized by that a rotation command is generated in real time in such a manner that the normal line direction of a surface of a workpiece does not change by obtaining normal line information on the surface of the workpiece at a current measurement point based on the coordinate values of the current measurement point.

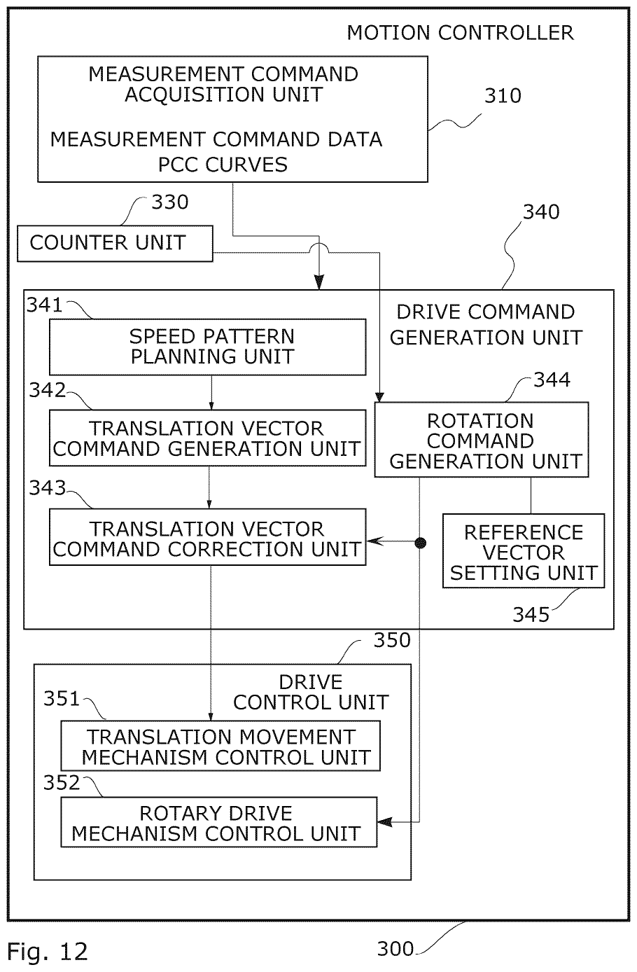

FIG. 12 shows a configuration of a motion controller 300 in the second exemplary embodiment.

Compared to the first exemplary embodiment (FIG. 8), a rotation command generation unit 344 receives position information in real time from a counter unit 330. As a result, the rotation command generation unit 344 always obtains information on the coordinate values (current measurement point) of the surface of the workpiece currently being measured by a stylus 433 of a probe 400 (surface roughness measuring unit 400).

In addition, the rotation command generation unit 344 is attached with a reference vector setting unit (reference direction setting unit) 345. The reference vector setting unit 345 sets and stores a reference direction (reference vector).

For example, the reference vector is the normal line direction (normal line vector) of the surface of the workpiece at the initial start point. The normal line direction (normal line vector) of the surface of the workpiece at the initial start point is contained in measurement command data. The reference vector setting unit 345 sets and stores the normal line direction (normal line vector) of the surface of the workpiece at the initial start point as a reference vector Nb.

In the first exemplary embodiment, the rotation command generation unit 344 obtains the change in the normal line direction between the start point and end point of a segment, and generates (plans) a rotation command in such a manner that the normal line direction does not change between the start point and end point of the segment. In the second exemplary embodiment, the rotation command generation unit 344 generates a rotation command at all times in such a manner that the normal line direction of a workpiece at the current measurement point is parallel to the reference vector N_{b}. In other words, in the second exemplary embodiment, the orientation of the normal line of the workpiece is constrained (bound) in such a manner that the normal line direction of the workpiece at the measurement point is always parallel to the reference vector Nb by rotating the workpiece using the rotary drive mechanism 230.

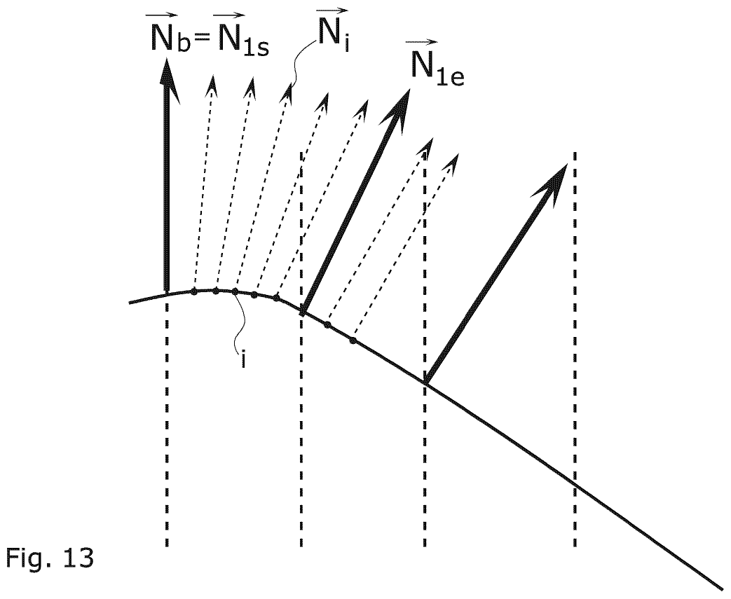

For example, as shown in FIG. 13, during a scanning measurement on a single segment, the normal line direction of the surface of a workpiece changes constantly.

The rotation command generation unit 344 extracts information on a workpiece normal line vector (current normal line direction) Ni at the current measurement point at all times (or at a predetermined control cycle pitch) from the measurement command data based on position information obtained in real time from the counter unit 330. Then, the angle formed between the workpiece normal line vector Ni at the current measurement point and the reference vector N_{b} is expressed as Δθp(Ni;N_{b}).

At this time, a rotation command oi is set as follows.

ωi=Δi(Ni;N_{b})/tc

Here, tc is, for example, the predetermined control cycle pitch.

Once the rotation command is determined in this manner, the subsequent processing can be performed in the same manner as in the first exemplary embodiment.

The translation vector command correction unit 343 performs correction processing on the translation vector command Vf generated by the translation vector command generation unit 342 so as to compensate for the rotation of the rotary drive mechanism 230, and generates a corrected translation vector command Vf_{AMD}.

The translation movement mechanism 220 and the rotary drive mechanism 230 are driven by the corrected translation vector command and the rotation command generated in this manner. Then, during the scanning measurement, the normal line direction of the surface of the workpiece at the measurement point does not change. For example, if the stylus 433 approaches the surface of the workpiece so as to be perpendicular to the surface of the workpiece at the initial start point, the stylus 433 will always remain perpendicular to the surface of the workpiece during subsequent scanning measurements.

Note that, the first exemplary embodiment and the second exemplary embodiment may each be implemented independently, but combining the first exemplary embodiment and the second exemplary embodiment is preferable.

In the first exemplary embodiment, a rotation command for each segment is roughly planned, and the relative posture between the normal line of the workpiece and the probe measurement axis is controlled at the start point and the end point of the segment. By combining this with the second exemplary embodiment, the relative posture between the workpiece and the probe 400 is continuously and finely controlled (adjusted) based on the normal line of the workpiece at the actual measurement point. This is also intended to handle minute changes in the surface of the workpiece (the normal line direction of the workpiece) in the segment and to perform fine adjustments depending on the actual drive errors.

### (First Modification)

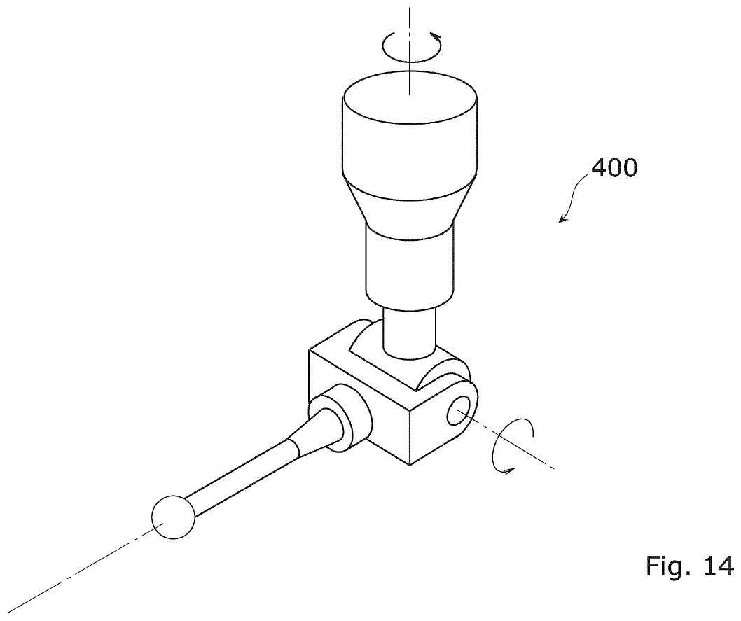

As shown in FIG. 14, the probe 400 having a rotation axis (rotation drive axis) is known.

FIG. 14 shows the probe 400 having two rotation axes as an example, but the probe 400 may have a single rotation axis.

In the present invention, the probe 400 having such a rotation axis (axes) may be employed. In this case, a rotary table for rotating a workpiece may be provided or may not be provided. In addition, as a combination variation, the probe 400 having a single rotation axis may be combined with a rotary table mechanism. It is needless to say, the probe 400 having two rotation axes may be combined with an inclined rotary table mechanism. Even if the number of rotation axes is two or more, the generation of a rotation command and the correction of a translation vector command are possible regardless of the positional configuration of the combination of rotation axes and Translation axes.

### (Second Modification)

The probe 400 is not limited to the surface roughness measuring unit 400.

The probe 400 whose relative posture with respect to the surface of a workpiece (relative posture of the probe measurement axis) affects detection accuracy is expected to achieve significantly improved measurement accuracy through the application of the present invention. An example of such the probe 400 is a single-axis probe 400 having a detection function only in a one-dimensional direction along a single measurement axis line. The surface roughness measuring unit 400 described in the above exemplary embodiments can also be considered an example of a single-axis probe 400 having a detection function only in a one-dimensional direction.

In addition, for example, contact-type probes include electrical (linear-moving type or lever-type) micrometers, and non-contact-type probes include so-called laser probes, chromatic point sensors (CPS), and capacitive non-contact-type sensors (which can broadly be called as non-contact-type surface shape sensors). These single-axis probes have high detection resolution and accuracy. However, they require adjustment of the relative posture with the surface of a workpiece. In this regard, the application of the present invention is expected to enable the use of these high-accuracy sensors in a simpler manner and improve measurement accuracy.

The probe 400 applicable to the present invention is not limited to probes with a single measurement axis line.

For example, the probe 400 may include a stylus with a spherical contact point at its tip, which is pressed against a workpiece, and the three-dimensional displacement of the contact point (stylus) is detected by a probe sensor.

In other words, the probe 400 includes a contact point at the tip of a longitudinal axis body. Note that, the contact point may be a contact type or non-contact type.

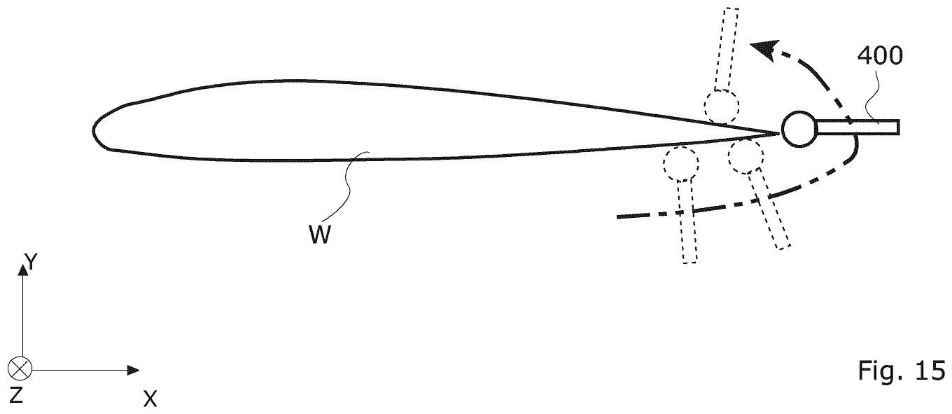

In this case, for example, as shown in FIG. 15, in a measurement of the shape of a curved workpiece, such as an aircraft turbine blade with significant curvature changes, if the posture between the probe 400 and the workpiece can be controlled (adjusted) in such a manner that the stylus always faces in a direction parallel to the normal line direction of the workpiece, it is possible to prevent interference between the stylus and the workpiece while the probe 400 measures around the workpiece.

The present invention is not limited to the above exemplary embodiments and may be appropriately modified within the scope of the invention.

The minimum configuration of the movement mechanisms (the translation movement mechanism and the rotary drive mechanism) may include a case where the translation movement mechanism has one translation movement axis and the rotary drive mechanism has one rotation drive axis.

The following supplemental notes are disclosed regarding the above embodiments.

### (Supplemental Note 1)

A shape measuring apparatus comprising:
a translation movement mechanism; and
a rotary drive mechanism, wherein
the translation movement mechanism and the rotary drive mechanism are configured to relatively move a probe and a workpiece in such a manner that the probe performs a scanning measurement on the workpiece along a preset scanning path, and
the rotary drive mechanism is driven and controlled in such a manner that an angle formed between the probe and a surface of the workpiece is a desired angle in synchronization with the translation movement mechanism relatively moving the probe and the workpiece.

### (Supplemental Note 2)

The shape measuring apparatus according to Supplemental note 1, further comprising:
a translation vector command generation unit configured to generate a translation vector command to drive and control the translation movement mechanism in such a manner that the probe moves along the scanning path;
a rotation command generation unit configured to generate a rotation command for the rotary drive mechanism in such a manner that the angle formed between the probe and the surface of the workpiece is the desired angle;
a translation vector command correction unit configured to correct the translation vector command so as to compensate for a component of the rotation command to generate a corrected translation vector command; and
a drive control unit configured to drive and control the translation movement mechanism based on the corrected translation vector command, drive and control the rotary drive mechanism based on the rotation command, and drive and control the translation movement mechanism and the rotary drive mechanism so as to be synchronized.

### (Supplemental Note 3)

The shape measuring apparatus according to Supplemental note 1, wherein the rotary drive mechanism is driven and controlled in such a manner that the angle formed between a measurement axis line of the probe and the surface of the workpiece is the desired angle.

### (Supplemental Note 4)

The shape measuring apparatus according to Supplemental note 1, wherein
the probe has a longitudinal shape, and
the rotary drive mechanism is driven and controlled in such a manner that the angle formed between a longitudinal axial direction of the probe and the surface of the workpiece is the desired angle.

### (Supplemental Note 5)

The shape measuring apparatus according to Supplemental note 2, wherein the rotation command generation unit is configured to obtain information on a normal line direction of the workpiece at each measurement point directly or indirectly from information on a normal line direction of the workpiece contained in design data about the scanning path.

### (Supplemental Note 6)

The shape measuring apparatus according to Supplemental note 2 further comprising:
a speed pattern planning unit configured to divide the scanning path into a plurality of segments, and set a speed pattern suitable for each segment to generate a speed pattern plan, wherein
the rotation command generation unit is configured to obtain, for each segment, an angle formed between a normal line of the surface of the workpiece at a start point of the segment and a normal line of the surface of the workpiece at an end point of the segment as a segment-to-segment normal line angle, and generate, for each segment, the rotation command so as to cancel out the segment-to-segment normal line angle.

### (Supplemental Note 7)

The shape measuring apparatus according to Supplemental note 2, further comprising:
a reference direction setting unit configured to set a reference direction, wherein
the rotation command generation unit is configured to acquire in real time coordinate values of the surface of the workpiece currently being measured by the probe as a current measurement point, obtain a normal line of the surface of the workpiece at the current measurement point based on the coordinate values at the current measurement point as a current normal line direction, and generate the rotation command so as to cancel out an angle formed between the reference direction and the current normal line direction.

### (Supplemental Note 8)

The shape measuring apparatus according to Supplemental note 1, wherein the desired angle formed between the probe and the surface of the workpiece is a right angle.

### (Supplemental Note 9)

The shape measuring apparatus according to Supplemental note 1, wherein the probe is a one-dimensional probe having a detection function in a one-dimensional direction along a single measurement axis line.

### (Supplemental Note 10)

The shape measuring apparatus according to Supplemental note 1, wherein the probe is a surface roughness measuring unit including a stylus configured to perform a scanning movement along the surface of the workpiece, and a displacement detection part configured to detect a displacement of the stylus in a direction perpendicular to the surface of the workpiece.

### (Supplemental Note 11)

A control method of a shape measuring apparatus including a translation movement mechanism and a rotary drive mechanism, the translation movement mechanism and the rotary drive mechanism being configured to relatively move a probe and a workpiece in such a manner that the probe performs a scanning measurement on the workpiece along a preset scanning path, the control method comprising:
driving and controlling the rotary drive mechanism in such a manner that an angle formed between the probe and a surface of the workpiece is a desired angle in synchronization with the translation movement mechanism relatively moving the probe and the workpiece.

### (Supplemental Note 12)

The control method of the shape measuring apparatus according to Supplemental note 11, further comprising:
generating a translation vector command to drive and control the translation movement mechanism in such a manner that the probe moves along the scanning path;
generating a rotation command for the rotary drive mechanism in such a manner that the angle formed between the probe and the surface of the workpiece is the desired angle;
correcting the translation vector command so as to compensate for a component of the rotation command to generate a corrected translation vector command; and
driving and controlling the translation movement mechanism based on the corrected translation vector command, driving and controlling the rotary drive mechanism based on the rotation command, and driving and controlling the translation movement mechanism and the rotary drive mechanism so as to be synchronized.

### (Supplemental Note 13)

The control method of the shape measuring apparatus according to Supplemental note 11, wherein during the scanning measurement on the workpiece, only one translation drive axis of the translation movement mechanism and one rotation drive axis of the rotary drive mechanism are driven simultaneously.

### (Supplemental Note 14)

The control method of the shape measuring apparatus according to Supplemental note 11, wherein
the probe is supported by the translation movement mechanism so as to be moved only by the translation movement mechanism,
the workpiece is supported so as to be rotated at least by the rotary drive mechanism,
a posture of the probe does not change, and
a normal line direction of the workpiece at each measurement point maintains the same direction.

### (Supplemental Note 15)

A non-volatile recording medium recording a measurement control program causing a computer, the computer is incorporated in a shape measuring apparatus including a translation movement mechanism and a rotary drive mechanism, the translation movement mechanism and the rotary drive mechanism being configured to relatively move a probe and a workpiece in such a manner that the probe performs a scanning measurement on the workpiece along a preset scanning path, to function as:
a control unit configured to drive and control the rotary drive mechanism in such a manner that an angle formed between the probe and a surface of the workpiece is a desired angle in synchronization with the translation movement mechanism relatively moving the probe and the workpiece.

### (Supplemental Note 16)

The non-volatile recording medium recording the measurement control program according to Supplemental note 15, wherein
the measurement control program causes the computer to function as:
a translation vector command generation unit configured to generate a translation vector command to drive and control the translation movement mechanism in such a manner that the probe moves along the scanning path;
a rotation command generation unit configured to generate a rotation command for the rotary drive mechanism in such a manner that the angle formed between the probe and the surface of the workpiece is the desired angle;
a translation vector command correction unit configured to correct the translation vector command so as to compensate for a component of the rotation command to generate a corrected translation vector command; and
a drive control unit configured to drive and control the translation movement mechanism based on the corrected translation vector command, drive and control the rotary drive mechanism based on the rotation command, and drive and control the translation movement mechanism and the rotary drive mechanism so as to be synchronized.

### REFERENCE SIGNS LIST

10 Shape measuring system
200 Coordinate Measuring Machine
210 Measuring table
220 Translation movement mechanism
221 Y slider
222 X slider
223 Z-axis column
224 Z spindle
400 Probe
400 Surface roughness measuring unit
410 Stylus unit
420 Case body
421 Trunk part
422 Nose part
423 Skid
424 Through hole
430 Stylus lever
431 Rocking lever
432 Plate spring
433 Stylus
440 Displacement detection part
441 Ferrite plate
442 Inductance detector
450 Outer housing
460 Joint
230 Rotary drive mechanism
300 Motion controller
310 Measurement command acquisition unit
330 Counter unit
340 Drive command generation unit
341 Speed pattern planning unit
342 Translation Vector Command Generation unit
343 Translation Vector Command Correction unit
344 Rotation command generation unit
345 Reference vector setting unit (reference direction setting unit)
350 Drive control unit
351 Translation movement mechanism control unit
352 Rotary drive mechanism control unit
500 Host computer
511 CPU
520 Storage unit
530 Shape analysis unit

1. A shape measuring apparatus comprising:
a translation movement mechanism; and
a rotary drive mechanism, wherein
the translation movement mechanism and the rotary drive mechanism are configured to relatively move a probe and a workpiece in such a manner that the probe performs a scanning measurement on the workpiece along a preset scanning path, and
the rotary drive mechanism is driven and controlled in such a manner that an angle formed between the probe and a surface of the workpiece is a desired angle in synchronization with the translation movement mechanism relatively moving the probe and the workpiece.

2. The shape measuring apparatus according to claim 1, further comprising:
a translation vector command generation unit configured to generate a translation vector command to drive and control the translation movement mechanism in such a manner that the probe moves along the scanning path;
a rotation command generation unit configured to generate a rotation command for the rotary drive mechanism in such a manner that the angle formed between the probe and the surface of the workpiece is the desired angle;
a translation vector command correction unit configured to correct the translation vector command so as to compensate for a component of the rotation command to generate a corrected translation vector command; and
a drive control unit configured to drive and control the translation movement mechanism based on the corrected translation vector command, drive and control the rotary drive mechanism based on the rotation command, and drive and control the translation movement mechanism and the rotary drive mechanism so as to be synchronized.

3. The shape measuring apparatus according to claim 1, wherein the rotary drive mechanism is driven and controlled in such a manner that the angle formed between a measurement axis line of the probe and the surface of the workpiece is the desired angle.

4. The shape measuring apparatus according to claim 1, wherein
the probe has a longitudinal shape, and
the rotary drive mechanism is driven and controlled in such a manner that the angle formed between a longitudinal axial direction of the probe and the surface of the workpiece is the desired angle.

5. The shape measuring apparatus according to claim 2, wherein the rotation command generation unit is configured to obtain information on a normal line direction of the workpiece at each measurement point directly or indirectly from information on a normal line direction of the workpiece contained in design data about the scanning path.

6. The shape measuring apparatus according to claim 2 further comprising:
a speed pattern planning unit configured to divide the scanning path into a plurality of segments, and set a speed pattern suitable for each segment to generate a speed pattern plan, wherein
the rotation command generation unit is configured to obtain, for each segment, an angle formed between a normal line of the surface of the workpiece at a start point of the segment and a normal line of the surface of the workpiece at an end point of the segment as a segment-to-segment normal line angle, and generate, for each segment, the rotation command so as to cancel out the segment-to-segment normal line angle.

7. The shape measuring apparatus according to claim 2, further comprising:
a reference direction setting unit configured to set a reference direction, wherein
the rotation command generation unit is configured to acquire in real time coordinate values of the surface of the workpiece currently being measured by the probe as a current measurement point, obtain a normal line of the surface of the workpiece at the current measurement point based on the coordinate values at the current measurement point as a current normal line direction, and generate the rotation command so as to cancel out an angle formed between the reference direction and the current normal line direction.

8. The shape measuring apparatus according to claim 1, wherein the desired angle formed between the probe and the surface of the workpiece is a right angle.

9. The shape measuring apparatus according to claim 1, wherein the probe is a one-dimensional probe having a detection function in a one-dimensional direction along a single measurement axis line.

10. The shape measuring apparatus according to claim 1, wherein the probe is a surface roughness measuring unit including a stylus configured to perform a scanning movement along the surface of the workpiece, and a displacement detection part configured to detect a displacement of the stylus in a direction perpendicular to the surface of the workpiece.

11. A control method of a shape measuring apparatus including a translation movement mechanism and a rotary drive mechanism, the translation movement mechanism and the rotary drive mechanism being configured to relatively move a probe and a workpiece in such a manner that the probe performs a scanning measurement on the workpiece along a preset scanning path, the control method comprising:
driving and controlling the rotary drive mechanism in such a manner that an angle formed between the probe and a surface of the workpiece is a desired angle in synchronization with the translation movement mechanism relatively moving the probe and the workpiece.

12. The control method of the shape measuring apparatus according to claim 11, further comprising:
generating a translation vector command to drive and control the translation movement mechanism in such a manner that the probe moves along the scanning path;
generating a rotation command for the rotary drive mechanism in such a manner that the angle formed between the probe and the surface of the workpiece is the desired angle;
correcting the translation vector command so as to compensate for a component of the rotation command to generate a corrected translation vector command; and
driving and controlling the translation movement mechanism based on the corrected translation vector command, driving and controlling the rotary drive mechanism based on the rotation command, and driving and controlling the translation movement mechanism and the rotary drive mechanism so as to be synchronized.

13. The control method of the shape measuring apparatus according to claim 11, wherein during the scanning measurement on the workpiece, only one translation drive axis of the translation movement mechanism and one rotation drive axis of the rotary drive mechanism are driven simultaneously.

14. The control method of the shape measuring apparatus according to claim 11, wherein
the probe is supported by the translation movement mechanism so as to be moved only by the translation movement mechanism,
the workpiece is supported so as to be rotated at least by the rotary drive mechanism,
a posture of the probe does not change, and
a normal line direction of the workpiece at each measurement point maintains the same direction.

15. A non-volatile recording medium recording a measurement control program causing a computer, the computer is incorporated in a shape measuring apparatus including a translation movement mechanism and a rotary drive mechanism, the translation movement mechanism and the rotary drive mechanism being configured to relatively move a probe and a workpiece in such a manner that the probe performs a scanning measurement on the workpiece along a preset scanning path, to function as:
a control unit configured to drive and control the rotary drive mechanism in such a manner that an angle formed between the probe and a surface of the workpiece is a desired angle in synchronization with the translation movement mechanism relatively moving the probe and the workpiece.

16. The non-volatile recording medium recording the measurement control program according to claim 15, wherein
the measurement control program causes the computer to function as:
a translation vector command generation unit configured to generate a translation vector command to drive and control the translation movement mechanism in such a manner that the probe moves along the scanning path;
a rotation command generation unit configured to generate a rotation command for the rotary drive mechanism in such a manner that the angle formed between the probe and the surface of the workpiece is the desired angle;
a translation vector command correction unit configured to correct the translation vector command so as to compensate for a component of the rotation command to generate a corrected translation vector command; and
a drive control unit configured to drive and control the translation movement mechanism based on the corrected translation vector command, drive and control the rotary drive mechanism based on the rotation command and drive and control the translation movement mechanism and the rotary drive mechanism so as to be synchronized.
